(19) United States
(12) Patent Application Publication
(10) Pub. No.: US 2020/0182646 A1
(43) Pub. Date: Jun. 11, 2020

(54) SYSTEMS AND METHODS FOR DISPLAYING MAP INFORMATION

(71) Applicant: BEIJING DIDI INFINITY TECHNOLOGY AND DEVELOPMENT CO., LTD., Beijing (CN)

(72) Inventors: Xiangdong ZHU, Beijing (CN); Bolong LIU, Beijing (CN)

(73) Assignee: BEIJING DIDI INFINITY TECHNOLOGY AND DEVELOPMENT CO., LTD., Beijing (CN)

(21) Appl. No.: 16/790,832

(22) Filed: Feb. 14, 2020

Related U.S. Application Data
(63) Continuation of application No. PCT/CN2018/094119, filed on Jul. 2, 2018.

(30) Foreign Application Priority Data
Aug. 14, 2017 (CN) 201710693346.8
Sep. 13, 2017 (CN) 201710824140.4

(51) Int. Cl. G01C 21/36

(52) U.S. Cl. CPC G01C 21/367

(57) ABSTRACT

Systems and methods for displaying map information in a display region on a terminal device are disclosed. The system may include a processor and a display coupled to the processor. The processor may be configured to identify a display element in the display region. The processor may be further configured to receive position information of at least one map element, and identify a map portion to be displayed based on the position information, the map portion including the at least one map element. The processor is also configured to position the map portion in the display region such that the display element does not overlap with the at least one map element. The display may be configured to display the display region.

### CROSS REFERENCE TO RELATED APPLICATION

The present application is a continuation of International Application No. PCT/CN2018/094119, filed on Jul. 2, 2018, which is based on and claims the benefits of priority to Chinese Application No. 201710693346.8, filed Aug. 14, 2017, and Chinese Application No. 201710824140.4, filed Sep. 13, 2017, the entire contents of which are incorporated herein by reference.

### TECHNICAL FIELD

The present disclosure relates to providing transportation services, and more particularly, to methods and systems for automatically determining a pick-up location for a passenger upon a transportation service request.

### BACKGROUND

An online hailing platform (e.g., DiDi™ online) can receive a rideshare service request from a passenger and then route the service request to at least one transportation service provider (e.g., a taxi driver, a private car owner, or the like). The service request can be answered by a service provider, or assigned to a service provider if no one picks up the service request within a predetermined period.

The driver and the passenger may each communicate via an application installed on a terminal device such as a mobile phone. The application may display various information within a display region on the terminal device. For example, on the passenger terminal, the application may display driver and/or vehicle information, trip information, trip cost, and a navigation map, etc. On the driver terminal, the application may display passenger information, trip information, trip cost, and a navigation map, etc. The driver/passenger information and trip information may be displayed as bubbles on top of the navigation map. During the trip, the bubble information may change and thus block important information of the navigation map from the user, such as the current location of the vehicle.

Embodiments of the present disclosure provide methods and systems that address the aforementioned shortcomings.

### SUMMARY

Embodiments of the disclosure provide an exemplary system for displaying map information in a display region on a terminal device. The system may include a processor and a display coupled to the processor. The processor may be configured to identify a display element in the display region. The processor may be further configured to receive position information of at least one map element, and identify a map portion to be displayed based on the position information, the map portion including the at least one map element. The processor is also configured to position the map portion in the display region such that the display element does not overlap with the at least one map element. The display may be configured to display the display region.

Embodiments of the disclosure further disclose a computer-implemented method for displaying map information in a display region on a terminal device. The method may include identifying, by a processor, a display element in the display region. The method may further include receiving position information of at least one map element, and identifying, by the processor, a map portion to be displayed based on the position information. The map portion includes the at least one map element. The method may also include positioning, by the processor, the map portion in the display region such that the display element does not overlap with the at least one map element, and displaying the display region on the terminal device.

Embodiments of the disclosure further disclose a non-transitory computer-readable medium. The non-transitory computer-readable medium may store a set of instructions, when executed by at least one processor of an electronic device, cause the electronic device to perform a method for displaying map information in a display region on a terminal device. The method may include identifying a display element in the display region. The method may further include receiving position information of at least one map element, and identifying a map portion to be displayed based on the position information. The map portion includes the at least one map element. The method may also include positioning the map portion in the display region such that the display element does not overlap with the at least one map element, and displaying the display region on the terminal device.

It is to be understood that both the foregoing general description and the following detailed description are exemplary and explanatory only and are not restrictive of the invention, as claimed.

### BRIEF DESCRIPTION OF THE DRAWINGS

FIG. 1 illustrates a block diagram of an exemplary terminal device configured to display map information, according to embodiments of the disclosure.

FIG. 2A and FIG. 2B illustrate exemplary display regions showing a varying display element, according to embodiments of the disclosure.

FIG. 3A and FIG. 3B illustrate exemplary display regions showing a varying map element, according to embodiments of the disclosure.

FIG. 4 illustrates a flowchart of a first exemplary method for displaying map information in a display region, according to embodiments of the disclosure.

FIG. 5 illustrates determining a second exemplary method for displaying map information in a display region, according to embodiments of the disclosure.

### DETAILED DESCRIPTION

Reference will now be made in detail to the exemplary embodiments, examples of which are illustrated in the accompanying drawings. Wherever possible, the same reference numbers will be used throughout the drawings to refer to the same or like parts.

An aspect of the disclosure is directed to a system for displaying map information in a display region on a terminal device. In some embodiments, the system may be implemented as a part of an online hailing service, where a driver provides transportation service to a passenger using a service vehicle. In such a context, the terminal device may be a mobile phone, a wearable device, a PDA, etc. used by the driver (“a driver terminal”) or the passenger (“a passenger terminal”). The system may include a processor and a display couple to the processor. The processor may be configured to process and arrange map information to be displayed on the display.

In some embodiments, a certain region on the display screen may be set as the display region. The map information may be arranged to be displayed as various elements within the display region. Specifically, the processor may be configured to identify a display element (e.g., a display box for driver/vehicle information) and/or an information element (e.g., a bubble with trip information) in the display region. The processor may be further configured to receive position information of at least one map element (e.g., the vehicle current position, an origin of the trip, a destination of the trip, etc.). Based on the position information, the processor may be further configured to identify a map portion to be displayed, such that the map portion includes the at least one map element. The map portion may be arranged in the display region in a manner such that the display element and/or information element do not overlap with the at least one map element.

In some embodiments, the display element and/or information element may move or otherwise change based on updated information or upon user interactions. For example, the display box may by default display only the driver's name and vehicle model. Upon user interaction (e.g., clicking on the box), the display box may expand to display additional information such as vehicle license plate number or driver reviews, etc. As another example, the trip information may be periodically updated during the trip to indicate the estimated distance to destination and estimated arrival time. In the meantime, the map element, e.g., the current position of the vehicle, may continue to change its position. Consistent with the present disclosure, the processor may automatically adjust the map portion and its position in the display region based on the changes in the map element, the display element, and/or the information element.

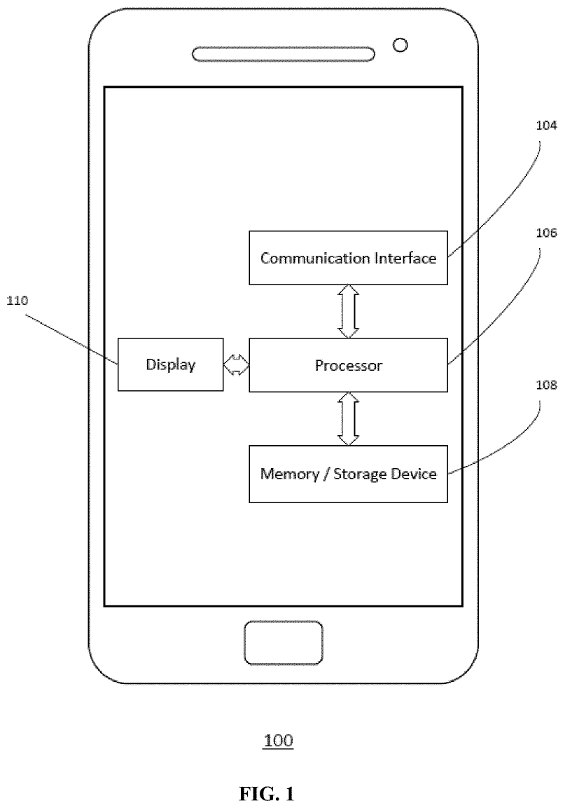

FIG. 1 is a block diagram depicting an exemplary terminal device 100, according to embodiments of the disclosure. Terminal device 100 may include any suitable device that can interact with a user, e.g., a smart phone, a tablet, a wearable device, a computer, or the like. In some embodiments, terminal device 100 may be a driver terminal used by the transportation service provider. In some other embodiments, terminal device 100 may be a passenger terminal used by the passenger requesting the transportation service. Description of terminal device 100 will be made using a passenger terminal as an example, but one skilled in the art will be able to adapt the described features of terminal device 100 to a driver terminal.

As shown by FIG. 1, terminal device 100 may include a communication interface 104, a processor 106, a memory/storage device 108, and a display 110. Communication interface 104 can be an integrated services digital network (ISDN) card, cable modem, satellite modem, or a modem to provide a data communication connection. As another example, communication interface 104 can be a local area network (LAN) card to provide a data communication connection to a compatible LAN. Wireless links can also be implemented by communication interface 104. In such an implementation, communication interface 104 can send and receive electrical, electromagnetic or optical signals that carry digital data streams representing various types of information via a network. The network can typically include a cellular communication network, a Wireless Local Area Network (WLAN), a Wide Area Network (WAN), or the like.

Communication interface 104 may be configured to send a transportation service request. Transportation service request may include, among other things, passenger information, a trip origin, a trip destination, or the like. The transportation service request may be accepted by or otherwise matched with a service vehicle. Communication interface 104 may be configured to receive driver and vehicle information from the service vehicle. Service vehicles may include taxi cars or private cars enrolled with an online hailing platform. In some embodiments, service vehicles may also include autonomous vehicles. The online hailing platform may maintain a database for storing profiles for the enrolled vehicles and the associated drivers. Vehicle information may include, e.g., vehicle position, vehicle year, maker, and model, as well as other features or characteristics associated with the service vehicle. Driver information includes, e.g., driver's name, driver's license number, driving record, driver's customer reviews.

Communication interface 104 may also be configured to receive updated trip information, e.g., current position of the vehicle, traffic data, map data, throughout the trip. In some embodiments, a navigation device onboard of the service vehicle or the driver terminal may provide the vehicle position to communication interface 104. In some embodiments, communication interface 104 may be configured to receive other data such as map data, real-time traffic information, weather information, road blocking information, etc. The updates may be received periodically, e.g., every 0.1 second, every second, every 5 seconds, or upon a user request.

Processor 106 may include any appropriate type of general-purpose or special-purpose microprocessor, digital signal processor, or microcontroller. Processor 106 may be configured as a separate processor module dedicated to rendering display of map information. Alternatively, processor 106 may be configured as a shared processor module for performing other functions unrelated to map information display. Processor 106 may include one or more hardware units (e.g., portions of an integrated circuit) designed for use with other components or to execute a part of a program. The program may be stored on a computer-readable medium, and when executed by processor 106, it may perform one or more functions.

Memory/storage device 108 may include any appropriate type of mass storage provided to store any type of information that processor 106 may need to operate. Memory/storage device 108 may be a volatile or non-volatile, magnetic, semiconductor, tape, optical, removable, non-removable, or other type of storage device or tangible (i.e., non-transitory) computer-readable medium including, but not limited to, a ROM, a flash memory, a dynamic RAM, and a static RAM. Memory/storage device 108 may be configured to store one or more computer programs that may be executed by processor 106 to render display of map information. For example, memory/storage device 108 may be configured to store program(s) that may be executed by processor 106 to arrange and update the various elements displayed within a display region.

Memory/storage device 108 may be further configured to store information and data used by processor 106. For instance, memory/storage device 108 may be configured to store the various types of data (e.g., transportation service request, vehicle information, driver information, updated trip information, map data, traffic data, etc.) received by communication interface 104. Memory/storage device 108 may also store intermediate data such as rendered map portions, size and shapes of the elements displayed in the display region, etc. The various types of data may be stored permanently, removed periodically, or disregarded immediately after each frame of data is processed.

Display 110 may include a display such as a Liquid Crystal Display (LCD), a Light Emitting Diode Display (LED), a plasma display, or any other type of display, and provide a Graphical User Interface (GUI) presented on the display for user input and data display. The display may include a number of different types of materials, such as plastic or glass, and may be touch-sensitive to receive commands from the user. For example, the display may include a touch-sensitive material that is substantially rigid, such as Gorilla Glass™, or substantially pliable, such as Willow Glass™.

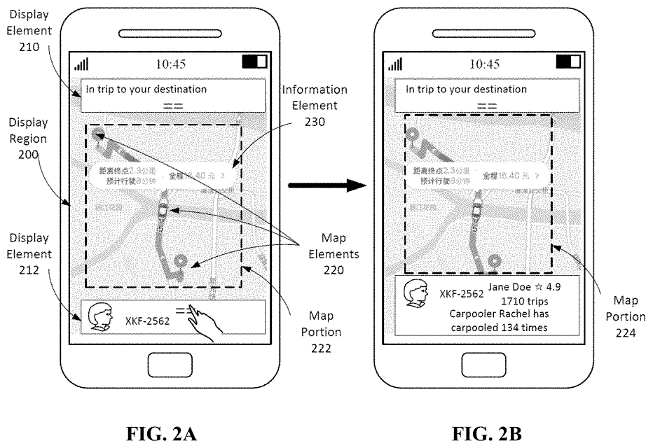

In some embodiments, processor 106 may be configured to render the various information to be displayed in a display region on display 110. For example, processor 106 may determine a relevant portion of the map data and render it into a map portion for displaying in a display region. Overplayed with the map portion, processor 106 may render various other elements, including e.g., map elements, display elements, and information elements, to be displayed within the display region. As shown in FIG. 2A and FIG. 2B, display region 200 may display a map portion 222, display elements 210 and 212, map elements 220, and information elements 230. Display element 210 may be a box showing trip status information. For example, it may show that the service vehicle has picked up the passenger and is currently in a trip to the passenger's destination. Display element 212 may be another box showing driver and vehicle information. Map portion 222 may be a portion of a map related to the ongoing trip. Map portion 222 may include showing of map elements 220, such as the origin of the trip, the destination of the trip, and current location of the vehicle.

In some embodiments, processor 106 may identify and render map portion 222 to show the current position of the vehicle as well as the trip origin/destination. Processor 106 may determine a center of map portion 222, as well as a center of the map area outside of an area covered by display elements 210-212, and position map portion 222 such that the two centers are substantially close to each other. For example, when only the vehicle's current position is shown as map element 220, processor 106 may use the position as the center of map portion 222 and determine the extent of map portion 222 based on a predetermined map scale. The predetermined map scale may be determined based on, e.g., the resolution of display 110. When there are multiple map elements 220, e.g., the destination and the current vehicle position, processor 106 may determine map portion 222 such that all map elements 220 are shown in map portion 222. In some embodiments, a geometric center of map elements 220 may be used as the center of map portion 222. For example, processor 106 may use a center point between the current vehicle position and the destination as the center to map portion 222.

In some embodiments, map portion 222 may additionally include showing of information elements 230, indicating trip information such as the distance to the destination, estimated remaining time before arrival, and the current cost of the trip. Consistent with the present disclosure, processor 106 may position the information elements in display region 200 such that information elements 230 do not overlap with any avoiding elements, including e.g., map elements 220 and display elements 210-212. In some embodiments, processor 106 may determine the shape and size of information elements 230 based on the amount of information to be included in the display. In some embodiments, processor 106 may position information element 230 based on the relative direction of the avoiding element to map element 220. For example, processor 106 may set map element 220 as the origin of a coordinate system, and divide display region 200 into four quadrants using axes of the coordinate system. The relative direction can be determined based on which quadrant avoiding element lies in. Information element 230 may be placed in a quadrant that is in the opposite direction from that of the avoiding element relative to map element 220. Accordingly, information element 230 will not block the avoiding element.

Consistent with the present disclosure, processor 106 may dynamically adjust the map portion as well as the various elements, according to, e.g., received updates or detected user interactions. In some embodiments, updates including e.g., current position of the service vehicle and real-time traffic data, may be received by terminal 100 periodically, e.g., every 3 seconds, 5 seconds, or 10 seconds. Based on the updated information, processor 106 may update and refresh the display of map portion 222 and map elements 220.

In some embodiments, a display element may have multiple states, and its state may change upon user interactions. For example, the size, the position, and/or the shape of the display element may change among different states. FIG. 2A and FIG. 2B illustrate exemplary display regions showing a varying display element 212 in display region 200, according to embodiments of the disclosure.

In some embodiments, display element 212 may have two states. In a first state (shown in FIG. 2A), display element 212 is collapsed and only shows a photo of the driver and the license plate of the service vehicle. When the passenger touches display element 212, processor 106 may detect the user interaction and accordingly adjust display element into a second state. For example, in the second state, display element 212 (shown in FIG. 2B) may expand and show additional information such as the driver's name (e.g., Jane Doe), review of the driver (e.g., 4.9 stars out of 5.0), and the number of trips she has serviced on the ride hailing platform (e.g., 1710 trips). The number of trips indicates how experienced the driver is and how often she provides the transportation service. Similarly, the review indicates how well she provides the service and the level of satisfaction by her passengers. In some embodiments, when a carpool service was requested, the expanded display element 212 may further show information associated with the carpooler, e.g., her name and the number of times she used carpooling service.

As display element 212 is expanded to show more information, the space taken up by display element 212 in display region 200 becomes larger. Consistent with the present disclosure, processor 106 may identify the position and size of display element 212 in display region and adjust other elements accordingly. For example, processor 106 may adjust the scale of map portion 222 or move map portion 222 accordingly to show the same information within a smaller region outside display element 212. The adjusted map portion 222 is shown in FIG. 2B as map portion 224. Processor 106 may position map portion 224 in display region 200 such that expanded display element 212 does not overlap with any of map elements 220 and information elements 230. Accordingly, display element 212 will not block any information displayed by map elements 220 and information elements 230.

In some embodiments, display element 212 may collapse again and return to its first state (shown by FIG. 2A) after the passenger touches it when it is in the second state. Accordingly, processor 106 may revert map portion 224 including map elements 220 and information elements 230 back to the map portion 222 in the first state. In some embodiments, processor 106 may automatically adjust display element 212 back to its first state after it is in its second state for a threshold period, such as 3 seconds, 5 seconds, or 10 seconds.

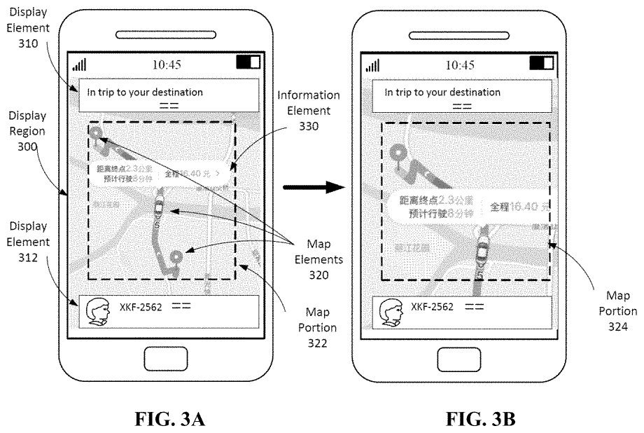

FIG. 3A and FIG. 3B illustrate exemplary display regions 300 showing varying map elements 320, according to embodiments of the disclosure. FIG. 3A and FIG. 3B show a map portion 322, display elements 310 and 312, map elements 320, and information elements 330 within display region 300. In FIG. 3A, map portion 322 including the origin of the trip, the destination of the trip, and the vehicle's current position is displayed. Processor 106 may use the geometric center of these three map elements as the center of map portion 322. In some embodiments, a user may interact with map portion 322 by e.g., touching the vehicle icon or the information element. For example, the user may touch information element 330 in FIG. 3A. In response, processor 106 may adjust the scale of map portion 322 to zoom in on selected map elements including the destination of the trip, and the vehicle's current position. The adjusted map portion 324 is shown in FIG. 3B. Accordingly, processor 106 may use the geometric center of just the destination and current position as the center of map portion 324, and determine the scale of the map portion based on the remaining display region outside of display elements 210 and 212. In some embodiments, the display may automatically return to FIG. 3A from FIG. 3B after a threshold period, such as 3 seconds, 5 seconds, or 10 seconds.

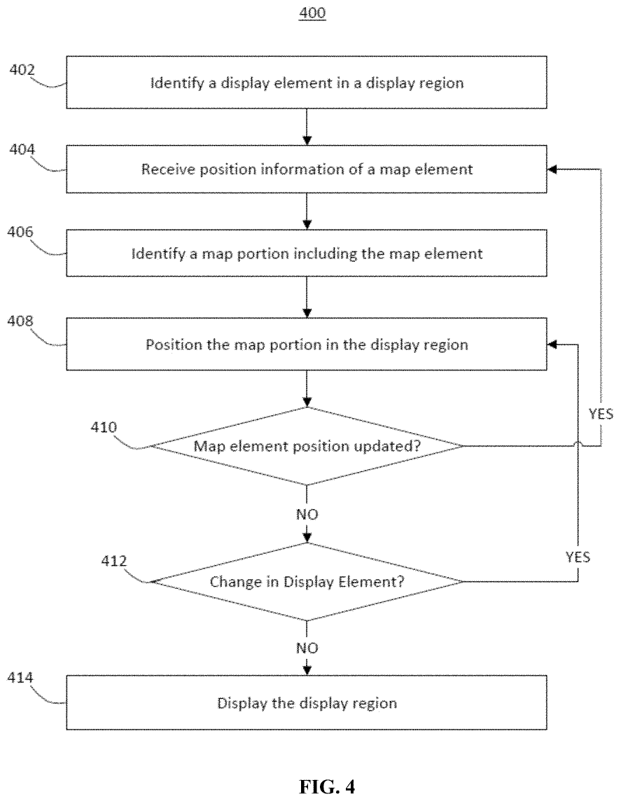

FIG. 4 is a flowchart illustrating an exemplary method 400 for displaying map information in a display region on a terminal device, consistent with disclosed embodiments. Method 400 may be implemented by terminal device 100. Method 400 may include steps 402-414 as described below. It is to be appreciated that some of the steps may be optional to perform the disclosure provided herein. Further, some of the steps may be performed simultaneously, or in a different order than shown in FIG. 4.

In step 402, terminal device 100 may identify a display element, e.g., display element 210 or 212, in display region 200. In some embodiments, display element 210 may be a box showing trip status information. For example, it may show that the service vehicle has picked up the passenger and is currently in a trip to the passenger's destination. Display element 212 may be another box showing driver and vehicle information. The display elements may be located at different areas within display region 200. In some embodiments, identifying the display element includes determining the shape, location, and size of the display element. For example, when display element is a rectangular box, its length and width may be determined. The display element may be located by determining its geometric center.

In step 404, terminal device 100 may receive position information of a map element, e.g., map element 220. In some embodiments, map elements 220 may include the origin of the trip, the destination of the trip, and the current location of the vehicle. The position information of the trip origin and destination may be included in the transportation service request. The current location of the vehicle may be measured by a positioning system onboard of the service vehicle. The vehicle location may be periodically updated and received by communication interface 104.

In step 406, terminal device 100 may identify a map portion, e.g., map portion 222, based on the position information. Map portion 222 may be a portion of a map related to the ongoing trip. Map elements 220 may be displayed on top of map portion 222 to indicate the origin, the destination, and the vehicle on the map. In some embodiments, processor 106 may determine the scale and extent of map portion 222 based on the positions of map elements 220. For example, processor 106 may determine a geometric center of map elements 220. For example, processor 106 may use a center point between the current vehicle position and the destination as the geometric center when map elements 220 include only these two positions. In some embodiments, the geographic coordinates (e.g., longitude and latitude of the location) may be determined for the geometric center and map elements 220. Using the geographic coordinates, processor 106 may locate the positions on a pre-stored map and extract a relevant portion to be displayed in display region 200.

In step 408, map portion 222 may be positioned in display region 200. In some embodiments, in order not to overlap with the display elements, processor may identify a map area outside of an area covered by the display elements. For example, a bounding box surrounding such a map area may be determined in display region 200. In some embodiments, processor 106 may determine a center of map portion 222, as well as a center of the map area outside of an area covered by display elements 210-212, and position map portion 222 such that the two centers are substantially close to each other. For example, when only the vehicle's current position is shown as map element 220, processor 106 may use the position as the center of map portion 222. When there are multiple map elements 220, e.g., the destination and the current vehicle position, processor 106 may use the geometric center of all map elements 220 as the center of map portion 222. In some embodiments, map portion 222 may be fit into the map area using a suitable scale. In some embodiments, the map scale may be predetermined based on, e.g., the resolution of display 110. In some embodiments, the map scale may be adaptively determined based on the distances between the geometric center and the respective positions of map elements 220 such that map elements 220 just fit into the map area.

In step 410, terminal device 100 may determine if the position of map element 220 has changed. For example, the passenger may update the trip destination during the trip. As another example, the vehicle location may be periodically updated, e.g., at every 3 seconds, 5 seconds, or 10 seconds, during the trip. If any such change occurs (step 410: yes), method 400 will return to step 404 to udpate map portion 222 based on the change in the map element. For example, the geometric center may be updated, and a different portion of the map may be extracted. Otherwise (step 410: no), method 400 may proceed to step 412.

In step 412, terminal device 100 may determine if any display element, e.g., 210 or 212, has changed. In some embodiments, the display element may change in size, shape, and/or location. In some embodiments, a display element may change upon receipt of updated information or upon user interactions. For example, display element 212 may have two states (shown in FIG. 2A and FIG. 2B): a first state that is collapsed and only shows a photo of the driver and the license plate of the service vehicle, and a second state that is expanded and shows additional information such as the driver's name (e.g., Jane Doe), review of the driver (e.g., 4.9 stars out of 5.0), the number of trips she has serviced on the ride hailing platform (e.g., 1710 trips), and carpooler information (e.g., carpooler name and the number of times she used carpooling service). Display element 212 may change between the two states upon a user interaction (e.g., user touches display element 212) or upon receiving certain updates.

If a change in a display element is detected (step 412: yes), method 400 will return to step 408 to adjust and/or re-position map portion 222. Processor 106 may first determine how the display element change affects the area taken up by the display element. Processor 106 may then re-determine the map area available for map portion 222 accordingly. Based on the determined map area, map portion 222 may be moved, zoomed in/out, or otherwise adjusted to fit into the map area. The adjusted map portion 222 becomes map portion 224. If no display element change is detected (step 412: no), method 400 may proceed to step 414 to display the map information in display region 200.

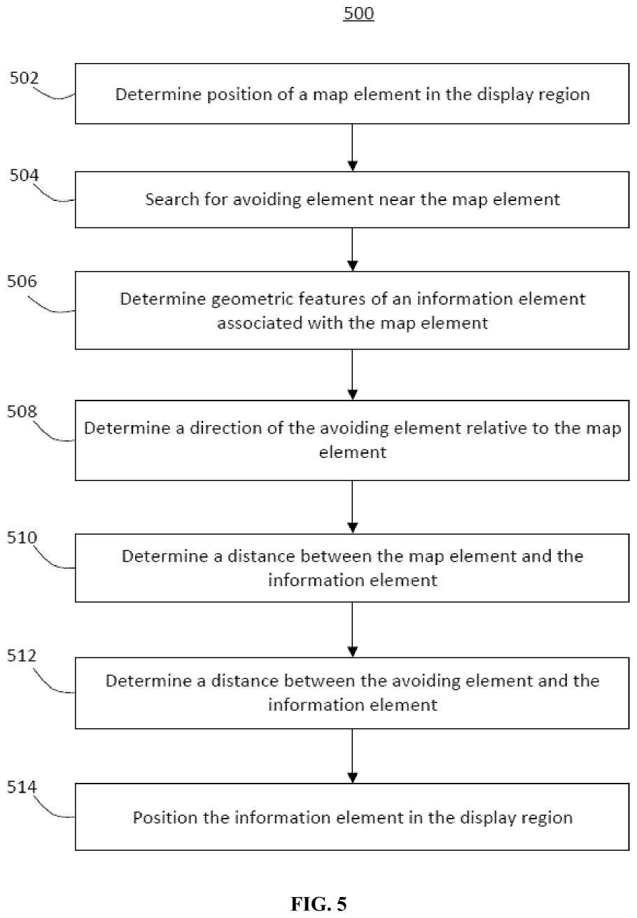

FIG. 5 is a flowchart illustrating another exemplary method 500 for displaying map information in a display region on a terminal device, consistent with disclosed embodiments. Method 500 may be implemented by terminal device 100. Method 500 may include steps 502-514 as described below. It is to be appreciated that some of the steps may be optional to perform the disclosure provided herein. Further, some of the steps may be performed simultaneously, or in a different order than shown in FIG. 5.

Method 500 may be specifically directed to a process of positioning an information element associated with the map element, such as information element 230, in display region 200. In some embodiments, information element may be a box showing trip information such as the distance to the destination, estimated remaining time before arrival, and the current cost of the trip. Consistent with the present disclosure, processor 106 may position information elements 230 in display region 200 such that they do not overlap with any avoiding elements. Avoiding elements may include, but not limited to, other map elements, display elements, information elements, etc. that an element should avoid.

In step 502, terminal device 100 may determine the position of a map element, such as map element 220, in display region 200. In some embodiments, the position of map element 220, such as the vehicle's current location, may be periodically updated, e.g., at every 3 seconds, 5 seconds, or 10 seconds.

In step 504, terminal device 100 may search for avoiding elements near the map element. In some embodiments, the search area may be within a predetermined distance from map element 220. For example, the search area may be a circular area within a predetermined radius from the position of map element 220. In some embodiments, an object meeting predetermined search criteria may be identified as an avoiding element. For example, the predetermined search criteria may include a shape (e.g., rectangular, square, oval, or circular) or a size (e.g., area larger than 3 mm² or 5 mm²).

In step 506, terminal device 100 may determine geometric features of an information element associated with the map element. For example, terminal device 100 may determine the shape and size of information element 230 based on the amount of information to be included in the display. In some embodiments, dimensions of the information element (e.g., radius if the information element is circular in shape, or length and width if the information element is rectangular) may be determined.

In step 508, terminal device 100 may determine the direction of avoiding element relative to its associated map element 220. In some embodiments, processor 106 may set map element 220 as the origin of a coordinate system, and divide display region 200 into four quadrants (e.g., quadrants I, II, III, and IV) using axes of the coordinate system. The relative direction can be determined based on which quadrant the avoiding element lies in. For example, if an avoiding element lies in quadrant I (the upper left quadrant), it is northwest to the map element.

In step 510, terminal device 100 may determine a distance between map element 220 and information element 230. In some embodiments, processor 106 may first determine a geometric center of information element 230, and then determine the distances between map element 220 and the geometric center. In step 512, terminal device 100 may determine a distance between the avoiding element and information element 230. Similarly, processor 106 may first determine the geometric centers of information element 230 and the avoiding element, and then determine the distance between the two geometric centers.

In step 514, terminal device 100 may position information element 230 in display region 200. In some embodiments, terminal device 100 may position information element 230 in a direction relative to the map element that is substantially opposite to the relative direction of the avoiding element determined in step 508. For example, if the avoiding element is in quadrant I, terminal device 100 may position information element 230 in quadrant III relative to map element 220.

In some embodiments, as part of step 514, terminal device 100 may position information element 230 such that the distance between the map element and the information element (as determined in step 510) is below a first threshold distance, and the distance between the avoiding element and the information element (as determined in step 512) is below a second threshold distance. The first and second threshold distances may be, e.g., 5 mm, 10 mm, or 15 mm.

Another aspect of the disclosure is directed to a non-transitory computer-readable medium storing instructions which, when executed, cause one or more processors to perform the methods, as discussed above. The computer-readable medium may include volatile or non-volatile, magnetic, semiconductor, tape, optical, removable, non-removable, or other types of computer-readable medium or computer-readable storage devices. For example, the computer-readable medium may be the storage device or the memory module having the computer instructions stored thereon, as disclosed. In some embodiments, the computer-readable medium may be a disc or a flash drive having the computer instructions stored thereon.

It will be apparent to those skilled in the art that various modifications and variations can be made to the disclosed system and related methods. Other embodiments will be apparent to those skilled in the art from consideration of the specification and practice of the disclosed system and related methods.

It is intended that the specification and examples be considered as exemplary only, with a true scope being indicated by the following claims and their equivalents.

1. A system for displaying map information in a display region on a terminal device, comprising:
a processor configured to:
identify a display element in the display region;
receive position information of at least one map element;
identify a map portion to be displayed based on the position information, the map portion including the at least one map element;
position the map portion in the display region such that the display element does not overlap with the at least one map element; and
send the display region to be displayed on the terminal device.

2. The system of claim 1, wherein the processor is further configured to:
receive updated position information of the at least one map element; and
automatically adjust the map portion and its position in the display region based on the updated position information.

3. The system of claim 2, wherein the updated position information is received periodically from a positioning device.

4. The system of claim 1, wherein the processor is further configured to:
detect a change in the display element; and
automatically adjust the map portion and its position in the display region based on the change.

5. The system of claim 4, wherein the change in the display element includes at least one of: a change of size, a change of position, or a change of shape of the display element.

6. The system of claim 1, wherein the at least one map element includes at least one of a vehicle current position, a trip origin, or a trip destination.

7. The system of claim 1, wherein to position the map portion, the processor is further configured to:
determine a first center of the map portion;
determine a second center of a map area in the display region and outside of an area covered by the display element; and
position the map portion such that the first center is substantially close to the second center.

8. The system of claim 1, wherein the processor is further configured to position an information element associated with one of the at least one map element in the display region.

9. The system of claim 8, wherein the processor is further configured to:
determine at least one avoiding element in the display region within a threshold distance from the map element; and
position the information element such that the information element does not overlap with the at least one avoiding element.

10. The system of claim 9, wherein the processor is further configured to:
determine geometric features of the information element; and
position the information element based on the geometric features.

11. The system of claim 9, wherein the processor is further configured to:
determine a first direction of the at least one avoiding element relative to the map element; and
position the information element in a second direction relative to the map element, wherein the second direction is substantially opposite to the first direction.

12. The system of claim 9, wherein the processor is further configured to place the information element such that a first distance between the map element and a geometric center of the information element is below a first threshold distance, and a second distance between the at least one avoiding element and the geometric center of the information element is below a second threshold distance.

13. A computer-implemented method for displaying map information in a display region on a terminal device, comprising:
identifying, by a processor, a display element in the display region;
receiving position information of at least one map element;
identifying, by the processor, a map portion to be displayed based on the position information, the map portion including the at least one map element;
positioning, by the processor, the map portion in the display region such that the display element does not overlap with the at least one map element; and
sending the display region to be displayed on the terminal device.

14. The method of claim 13, further comprising:
receiving updated position information of the at least one map element periodically from a positioning device; and
automatically adjusting the map portion and its position in the display region based on the updated position information.

15. The method of claim 13, further comprising:
detecting a change in the display element, the change including at least one of a change of size, a change of position, or a change of shape of the display element; and
automatically adjusting the map portion and its position in the display region based on the change.

16. The method of claim 13, further comprising positioning an information element associated with one of the at least one map element in the display region.

17. The method of claim 16, wherein positioning the information element further comprises:
determining at least one avoiding element in the display region within a threshold distance from the map element; and
positioning the information element such that the information element does not overlap with the at least one avoiding element.

18. The method of claim 17, wherein positioning the information element further comprises:
determining geometric features of the information element; and
positioning the information element based on the geometric features.

19. The method of claim 17, wherein positioning the information element further comprises:
determining a first direction of the at least one avoiding element relative to the map element; and
positioning the information element in a second direction relative to the map element, wherein the second direction is substantially opposite to the first direction.

20. A non-transitory computer-readable medium that stores a set of instructions, when executed by at least one processor of an electronic device, cause the electronic device to perform a method for displaying map information in a display region on a terminal device, the method comprising:
identifying a display element in the display region;
receiving position information of at least one map element;
identifying a map portion to be displayed based on the position information, the map portion including the at least one map element;
positioning the map portion in the display region such that the display element does not overlap with the at least one map element; and
sending the display region to be displayed on the terminal device.
